(19) United States
(12) Patent Application Publication
(10) Pub. No.: US 2010/0088456 A1
(43) Pub. Date: Apr. 8, 2010

(54) STORAGE-SHARING BUS SWITCH

(76) Inventors: Shih-Tsung Chu, Sanchong City (TW); Yao-Tien Huang, Jhudong Township (TW)

Correspondence Address: SINORICA, LLC, 2275 Research Blvd., Suite 500, ROCKVILLE, MD, 20850, US

(21) Appl. No.: 12/330,868

(22) Filed: Dec. 9, 2008

(30) Foreign Application Priority Data
Oct. 3, 2008 (TW) 97138075

(51) Int. Cl. G06F 13/00

(52) U.S. Cl. 710/316

(57) ABSTRACT

The present invention discloses a storage-sharing bus switch, which comprises a bus exchange device, a controller and a plurality of non-transparent bridge devices. The bus used in the present invention is PCI or a like system bus. The bus exchange device connects with the controller and a plurality of storage devices and links to hosts via the non-transparent bridge devices. The storage-sharing bus switch executes data transmission between hosts and storage devices. The controller starts up and monitors the devices linking to the storage-sharing bus switch. The non-transparent bridge devices implement data transmission between hosts and the storage-sharing bus switch and separate the hosts from the devices linking to the storage-sharing bus switch lest operation errors damage the devices. The present invention enables a plurality of hosts to share data storage simultaneously.

### BACKGROUND OF THE INVENTION

1. Field of the Invention

The present invention relates to a bus switch enabling a plurality of hosts to share data storage.

2. Description of the Related Art

Refer to FIG. 1 for a conventional technology, wherein a storage exchanger 10 connects several hosts 12 and several storage devices 14 to form a storage network. The hosts 12 share the storage space of all the storage devices 14. Each storage device 12 has a storage interface connecting with the storage exchanger 12 via a communication channel, such as an optical fiber, an Ethernet or a Serial Attached SCSI. Each host 12 has a host bus adapter (HBA) performing signal and protocol transformation and bridging the system bus inside the host 12 and the storage interface. The abovementioned HBA, storage interface, and storage exchanger are only used in connecting storage devices. Therefore, they have low popularization rates and high prices. Further, protocol transformation degrades the data transmission performance. Considering system buses, such as PCI (Peripheral Component Interface), PCIx (PCI extended), and PCIe (PCI express), have been widely used in personal computers and servers and have high performance, high popularization rates and low prices, the present invention proposes a storage-sharing bus switch using a system bus to construct a storage network.

### SUMMARY OF THE INVENTION

The primary objective of the present invention is to provide a storage-sharing bus switch, which uses the existing system buses of hosts and a plurality of non-transparent bridge devices to bridge a plurality of hosts and a bus exchange device to form a system bus-based storage network, whereby the storage network needn't use the expensive host bus adapters and storage exchangers and has a lower price.

Another objective of the present invention is to provide a storage-sharing bus switch, wherein the non-transparent bridge devices are arranged inside the bus switch, or arranged inside the hosts and then connected to the bus switch.

A further objective of the present invention is to provide a storage-sharing bus switch, wherein a controller is arranged in the bus switch to administer the resources of the system buses and monitor the devices linking to the system buses, such as RAID (Redundant Array of Independent Discs) linking to the system bus interface.

To achieve the abovementioned objectives, the present invention proposes a storage-sharing bus switch, which comprises a bus exchange device and an embedded controller. The bus exchange device connects to at least one storage device and connects to at least one host via at least one non-transparent bridge device. The non-transparent bridge devices are arranged inside or outside the storage-sharing bus switch. The embedded controller connects with the exchange device and administers the hosts and storage devices.

Below, the embodiments are described in detail to make easily understood the objectives, technical contents, characteristics and accomplishments of the present invention.

### BRIEF DESCRIPTION OF THE DRAWINGS

FIG. 1 is a diagram schematically showing the connection of hosts and RAID in a conventional bus switch;

FIG. 2 is a diagram schematically showing a storage-sharing bus switch according to one embodiment of the present invention;

FIGS. 3-5 are diagrams schematically showing storage-sharing bus switches according to other embodiments of the present invention;

FIG. 6 is a diagram schematically showing that an exchange device of a storage-sharing bus switch is connected to another exchange device according to one embodiment of the present invention;

FIG. 7 is a diagram schematically showing a storage-sharing bus switch having a conversion bridge device according to one embodiment of the present invention; and

FIG. 8 is a diagram schematically showing a storage-sharing bus switch having an administration interface according to one embodiment of the present invention.

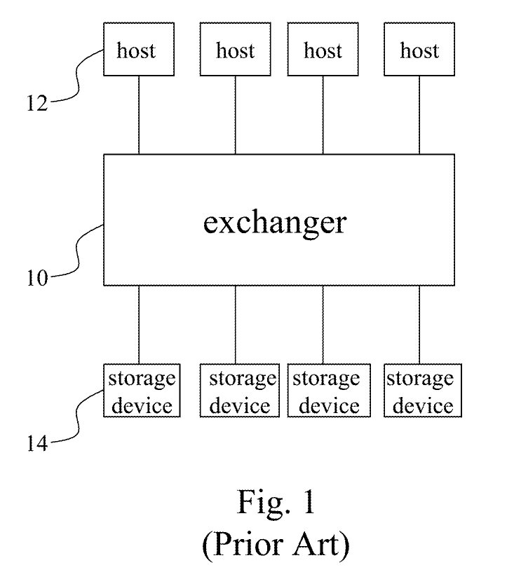

### DETAILED DESCRIPTION OF THE INVENTION

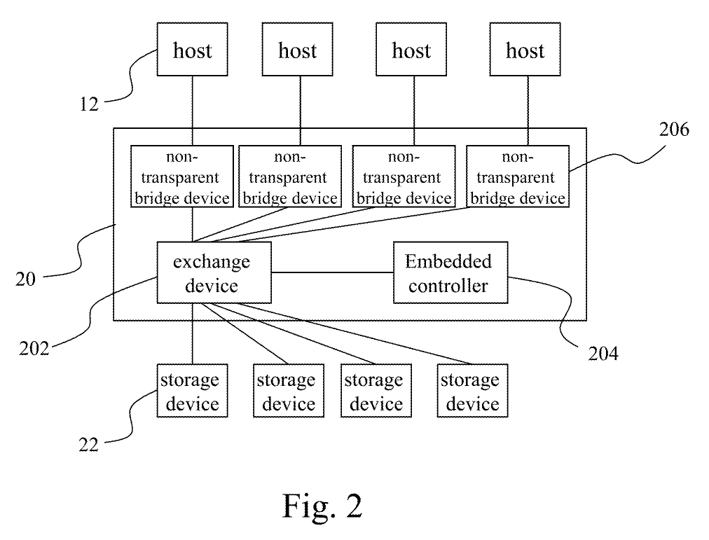

Refer to FIG. 2 for a storage-sharing bus switch according to one embodiment of the present invention. The storage-sharing bus switch 20 of the present invention comprises an exchange device 202, an embedded controller 204 and at least one non-transparent bridge device 206. The embedded controller 204 and non-transparent bridge devices 206 are connected with the exchange device 202. The exchange device 202 is connected to a plurality of external storage devices 22 and respectively uses the non-transparent bridge devices 206 to connect with hosts 12. In the present invention, the exchange device 202, embedded controller 204 and storage devices 22 all use system bus interfaces, such as PCI, PCIx, or PCIe. The system bus interface may be a serial connection interface. The embedded controller 204 administers the hosts 12 and the storage devices 22, initializing the storage devices 22, and distributes resources to the hosts 12. The host 12 is a computer having a system bus interface, such as a personal computer, a portable computer, or a server. The host 12 has a Redriver Card extending the system bus to externally connect with other system buses. The storage device 22 may be a RAID (Redundant Array of Independent Discs), a tape drive, a hard drive, an optical disc drive, or a semiconductor storage device.

When one host 12 or storage device 22 is connected to or removed from the bus switch 20, the embedded controller 204 will perceive the change of the connection state of the bus interface or receive a notification from an external detection circuit, and then the embedded controller 204 will take the corresponding actions. The embedded controller 204 also periodically detects the states of the connected hosts 12 and storage devices 22. When detecting none response from one host 12 or storage device 22, the embedded controller 204 will take device removal-related actions.

When one host 12 or storage device 22 is connected to the bus switch 20, I/O and memory resources will be distributed to the non-transparent bridge device 206 coupled to the host 12 or storage device 22, whereby the other devices linking to the bus can access the host 12 or storage device 22. According to the connection state of the hosts 12 and storage devices 22 and the resource application status, the embedded controller 204 dynamically allocate resources to the non-transparent bridge device 206 coupled to the host 12 or storage device 22 connected to the bus switch 20 latest. When one host 12 or storage device 22 is removed from the bus switch 20, the embedded controller 204 will take back the resources from the removed host 12 or storage device 22. According to the number of the connection ports of the bus switch 20 and the number of the hosts 12 and storage devices 22 connected with the bus switch 20, the embedded controller 204 may beforehand allocate resources to all the storage devices 22 and non-transparent bridge devices 206. Therefore, in the present invention, resources is dynamically allocated or recycled when the hosts 12 or storage devices 22 are added or removed, or resources are allocated to the devices beforehand and administered in a static mode.

The host 12 also has to detect whether it is connected to the bus switch 20 and persistently monitor the connection state. The host 12 also has to allocate I/O and memory resources to the non-transparent bridge device 206 coupled to it. Thereby, the host 12 can use the non-transparent bridge devices 206 to access other devices connected to the exchange device 202, including the other hosts 12 coupled to the other non-transparent bridge devices 206, the storage devices 22, and the embedded controller 204.

The embedded controller 204 informs all the hosts 12 connected to the bus switch 20 of the added or removed storage devices 22, whereby the hosts 12 can learn all the currently available storage devices 22 and reconfigure the internal storage setting, and then notifies the users.

After the resource configuration of one host 12 and the embedded controller 204 is done, the non-transparent bridge devices 206 connected to the host 12 can perform bidirectional data transmission. Once the address translation table is established, the non-transparent bridge device 206 can function to bridge the buses at two ends thereof.

The hosts 12 can control the storage devices 22 and read data from or write data into the storage devices 22 via the non-transparent bridge devices 206. Similarly, the storage devices 22 can read data from or write data into the system memories (not shown in the drawings) of the hosts 12 via the non-transparent bridge devices 206. Via the information exchange, the hosts 12 and storage devices 22 can undertake various administrations, controls and data transmissions.

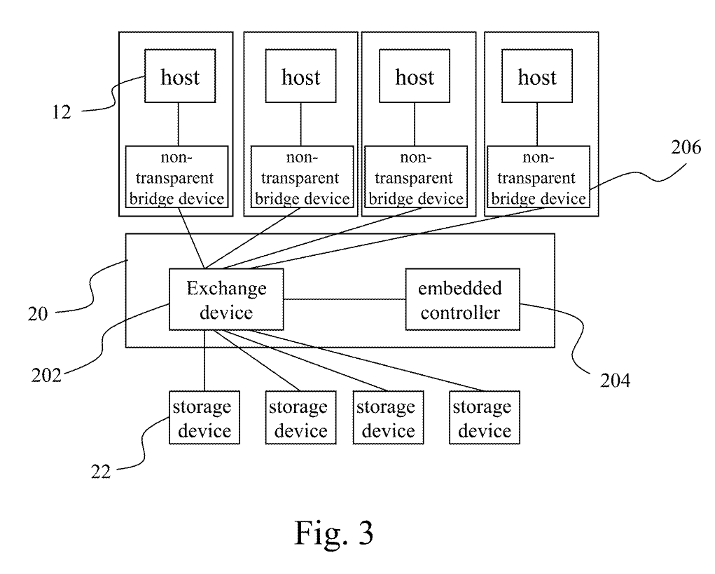

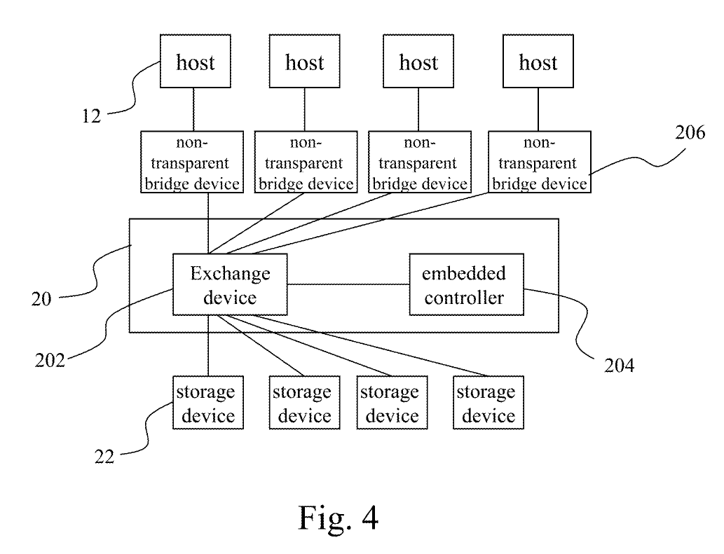

In the present invention, the non-transparent bridge devices 206 are built in the bus switch 20, or respectively arranged in the hosts 12 with the bus switch 20 containing only the exchange device 202 and the embedded controller 204, as shown in FIG. 3. Refer to FIG. 4. Alternatively, the non-transparent bridge devices 206 are arranged outside the hosts 12 and the bus switch 20 and respectively exist independently; in such a case, each host 12 still has to connect with one non-transparent bridge device 206. In the preceding embodiments, the installation positions of the non-transparent bridge devices 206 do not influence the operations of the hosts 12 and the storage devices 22 mentioned hereinbefore.

In the bus switch 20, the embedded controller 204 may also be in charge of the access security of the storage devices, wherein a plurality of virtual security zones is formed in between the hosts 12 and the storage devices, and wherein one host 12 cannot access the virtual security zones except the virtual security zones belong to it. The security zones may be designed to be the mapping relationship between the hosts and the storage devices or the access relationship among the connection ports of the bus switch 20.

The bus switch 20 may also support inter-device data duplication. When one host 12 instructs the embedded controller 204 to duplicate a piece of data from one storage device 22 to another storage device 22, the embedded controller 204 will represent the host 12 to control the two storage devices 22 and execute data duplication. After giving the instruction, the host 12 needn't participate in the succeeding data duplication and transmission. The data duplication and transmission is directly performed inside the bus switch 20. After the data duplication and transmission is completed, the embedded controller 204 will acknowledge the host 12.

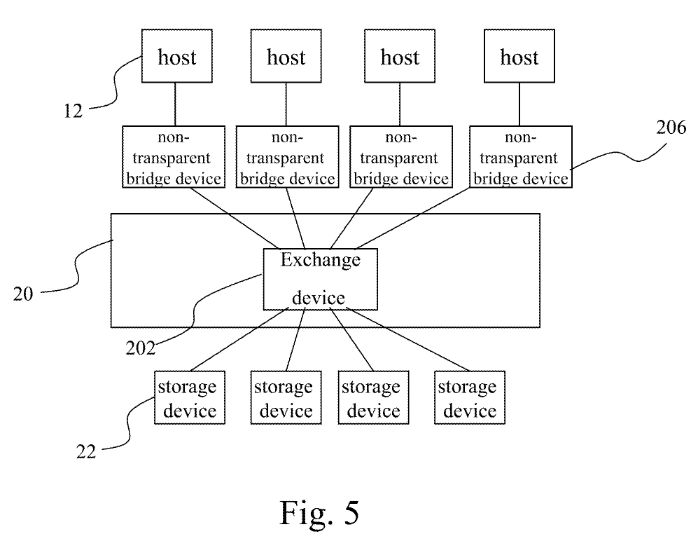

Refer to FIG. 5. In one embodiment, one host 12, which is connected to exchange device 202, functions as the external controller of the bus switch 20 to replace the embedded controller. Thus, there is none embedded controller inside the bus switch 20. In such a case, the non-transparent bridge device 206 coupled to the host 12 functioning as the external controller has to turn off the bridging function so that the host 12 can directly control all the non-transparent bridge devices 206 and storage devices 22 connected to the exchange device 202. When the host functioning as the external controller malfunctions, another host can take over the control task. In this embodiment, when one host functions as the primary external controller, another host may function as the standby secondary external controller. All the settings and states of the bus switch are synchronized in the two external controllers. Thereby, the task take-over can be undertaken smoothly. Which one of the hosts will function as the external controller may be determined according to the sequence by which the hosts connect to the connection ports of the bus switch 20.

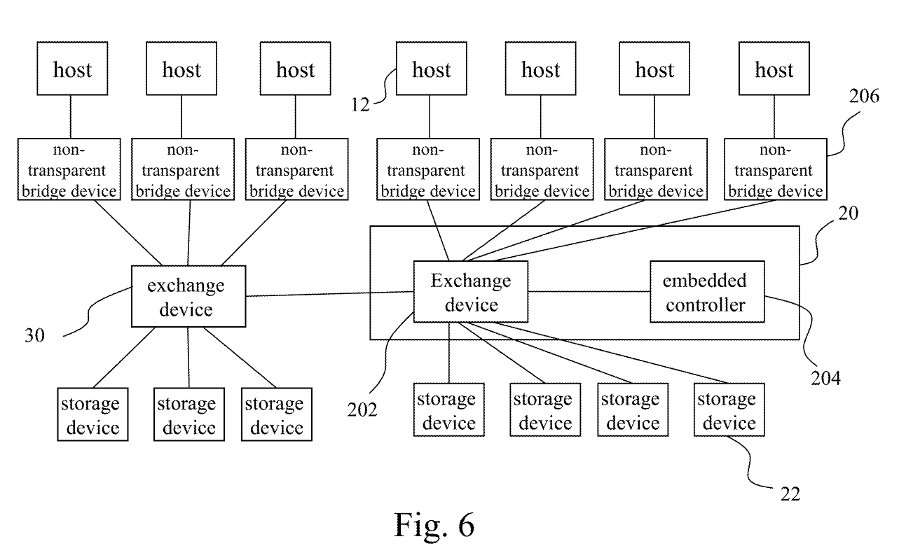

In one embodiment, the bus switch is connected with another exchange device. Refer to FIG. 6. An exchange device 30 is connected with the exchange device 202 of the bus switch 20. The exchange device 30 may be an exchange device of a bus switch with none embedded controller, such as the bus switch 20 in FIG. 5. Alternatively, the exchange device 30 is the exchange device of the bus switch 20 in FIG. 2 and FIG. 3. In such a case, the two embedded controllers have to coordinate to administer their respective tasks.

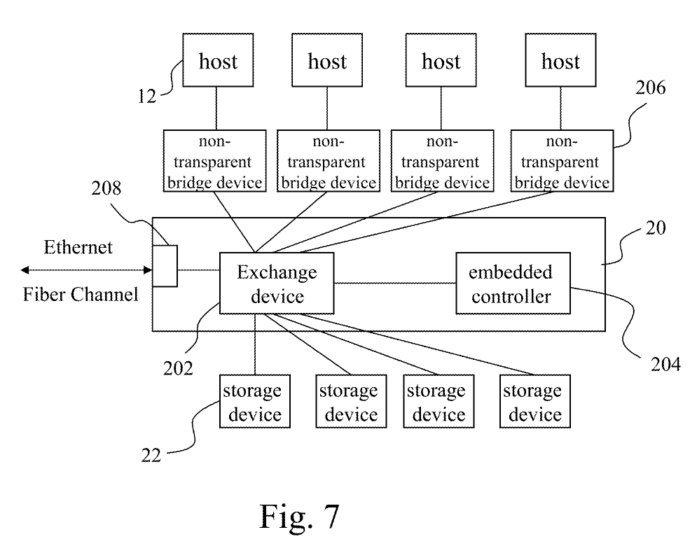

Refer to FIG. 7. In one embodiment, the bus switch 20 also has a conversion bridge device 208 connecting the system bus interface to an optical fiber channel or an Ethernet, whereby the bus switch 20 can communicate with the exchange device of another interface.

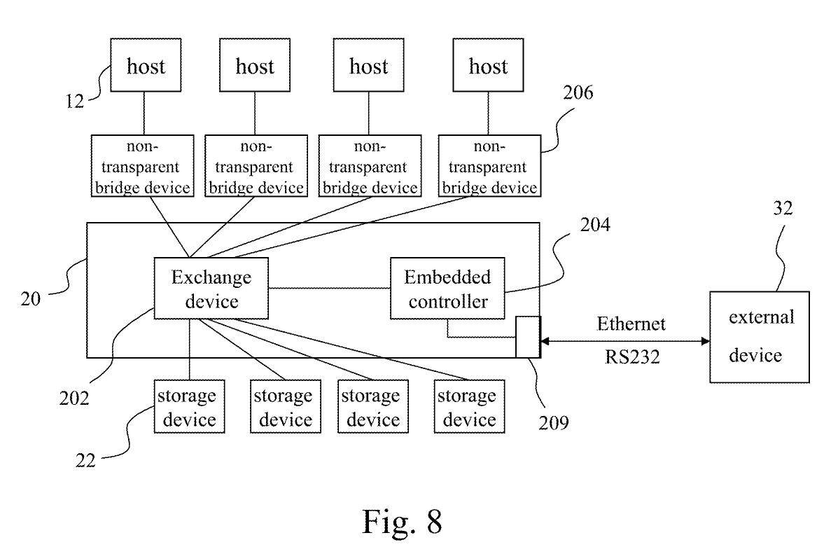

Refer to FIG. 8. In one embodiment, the bus switch 20 also has an administration interface 209, which is connected to an external device 32 via an Ethernet or an RS232 interface. Thereby, the user can link to the embedded controller 204 via the Ethernet or the RS232 interface and via the administration interface 209 to externally control or monitor the embedded controller 204, exchange device 202, hosts 12 and storage devices 22.

In conclusion, the storage-sharing bus switch of the present invention needn't use an expensive interface, such as optical fiber, but adopts an existing system bus, such as PCIe. Therefore, the present invention is cost-efficient. In the present invention, a plurality of hosts can simultaneously access the RAID linked by PCIe and share the data stored in RAID. The bus switch of the present invention can be used to form a PCIe-based storage network. In the present invention, an embedded controller is arranged in the bus switch to administer the memory resources and devices linked by PCIe, such as the storage devices in FIG. 2 and FIG. 3.

The embodiments described above are only to exemplify the present invention but not to limit the scope of the present invention. Therefore, any equivalent modification or variation according to the spirit of the present invention is to be also included within the scope of the present invention.

What is claimed is:

1. A storage-sharing bus switch comprising
an exchange device using a system bus interface, connected with at least one storage device and connected with at least one host via at least one non-transparent bridge device, wherein said host simultaneously access said storage device and share data stored in said storage device via said non-transparent bridge device.

2. The storage-sharing bus switch according to claim 1, wherein one of said host administers said host and said a storage device, undertakes initialization, and allocates resources.

3. The storage-sharing bus switch according to claim 1 further comprising an embedded controller, which is connected with said exchange device, and which administers said host and said storage device, undertakes initialization, allocates resources, assigns said storage device accessible to said host.

4. The storage-sharing bus switch according to claim 1, wherein said system bus interface is PCI (Peripheral Component Interface), PCIx (PCI extended), or PCIe (PCI express), and said storage device is a RAID (Redundant Array of Independent Discs), a tape drive, a hard drive, an optical disc drive, or a semiconductor storage device.

5. The storage-sharing bus switch according to claim 1, wherein said non-transparent bridge device is arranged inside said bus switch, respectively arranged inside said host, or independent from said host and said bus switch.

6. The storage-sharing bus switch according to claim 3, wherein when one of said host or one of said storage device is connected to said bus switch, said embedded controller perceives a change of a connection state of said system bus interface or receives a notification from an external detection circuit, and notifies said host; then, said host reconfigures an internal storage setting thereof and provides an I/O resource and a plurality of memory resources for said exchange device to initialize and start up said host or said storage device.

7. The storage-sharing bus switch according to claim 1, wherein resources are dynamically allocated or recycled when said host or said storage device is connected to or removed from said bus switch; alternatively, resources are allocated beforehand and administered in a static mode.

8. The storage-sharing bus switch according to claim 3, wherein said embedded controller further comprises a flash memory or a non-volatile memory for storing settings of said host and said storage device.

9. The storage-sharing bus switch according to claim 3 further comprising an administration interface for a user links to said embedded controller via said administration interface to externally control or monitor said embedded controller, said exchange device, said host and said storage device.

10. The storage-sharing bus switch according to claim 1 further comprising a conversion bridge device connecting said system bus interface to an optical fiber channel or an Ethernet.

11. A method for a storage-sharing bus switch connecting with a plurality of hosts and a plurality of storage devices via a system bus interface, comprising steps:
respectively connecting said hosts with an exchange device of said bus switch via non-transparent bridge devices;
using an embedded controller or one of said hosts to allocate resources of said bus switch and periodically detect connection state variation of said system bus interface; and
using said embedded controller to reconfigure settings of said bus switch when a connection state of said system bus interface varies.

12. The method for a storage-sharing bus switch according to claim 11, wherein said connection state variation is that a new host or a new storage device is connected to said bus switch, or that one of said hosts or one of said storage device is disconnected from said bus switch.

13. The method for a storage-sharing bus switch according to claim 11, wherein said non-transparent bridge devices are arranged inside said bus switch, respectively arranged inside said hosts, or independent from said hosts and said bus switch.

14. The method for a storage-sharing bus switch according to claim 12 further comprising a step: when a connection state of said system bus interface varies, said embedded controller notifying said hosts, and each of said hosts reconfiguring an internal storage setting thereof and provides an I/O resource and a plurality of memory resources for said exchange device to initialize and start up said new host or said new storage device.

15. The method for a storage-sharing bus switch according to claim 14, wherein when one of said hosts or one of said storage devices is removed, said memory resources are released, and said embedded controller retains resources of said storage devices, and said hosts reconfigure internal storage settings thereof.

16. The method for a storage-sharing bus switch according to claim 11, wherein said embedded controller assigns said storage devices accessible to said hosts.

17. The method for a storage-sharing bus switch according to claim 11, wherein said embedded controller further comprises a flash memory or a non-volatile memory for storing settings of said hosts and said storage devices.

18. The method for a storage-sharing bus switch according to claim 11 further comprising a step: using an administration interface connect said bus switch to an external device, whereby a user can link to said embedded controller via said administration interface to externally control or monitor said bus switch, said hosts connected to said bus switch, and said storage devices connected to said bus switch.

19. The method for a storage-sharing bus switch according to claim 11 further comprising a step: using a conversion bridge device to connecting said system bus interface to an optical fiber channel or an Ethernet.

20. The method for a storage-sharing bus switch according to claim 11, wherein said exchange device further has a data-duplication and transference function; when said host sends out a data duplication instruction, said exchange device receives said data duplication instruction and duplicates a piece of data of one of said storage devices to another one of said storage devices.
